(19) United States
(12) Patent Application Publication
(10) Pub. No.: US 2006/0211836 A1
(43) Pub. Date: Sep. 21, 2006

(54) Disproportionation of hydridosiloxanes and crosslinked polysiloxane network derived therefrom

(75) Inventors: Slawomir Rubinsztajn, Niskayuna, NY (US); James Anthony Cella, Clifton Park, NY (US); Patrick Roland Lucien Malenfant, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/081,070

(22) Filed: Mar. 15, 2005

(51) Int. Cl. C08G 77/20

(52) U.S. Cl. 528/31; 528/16

(57) ABSTRACT

Disclosed is a crosslinked polysiloxane network comprising both residual Si—H linkages and a Lewis acid catalyst, wherein the network is derived from a linear hydridosiloxane, a branched hydridosiloxane, a cyclic hydridosiloxane or a mixture of a linear hydridosiloxane or branched hydridosiloxane and a cyclic hydridosiloxane. Disclosed also is a method to produce the crosslinked polysiloxane network, alternatively accompanied by a silane with aliphatic, aromatic, or cycloaliphatic substituents by reacting in the presence of an effective amount of a Lewis acid catalyst a linear hydridosiloxane, a branched hydridosiloxane, a cyclic hydridosiloxane or a mixture of a linear hydridosiloxane or branched hydridosiloxane and a cyclic hydridosiloxane.

### BACKGROUND OF THE INVENTION

The present invention relates to the disproportionation of hydridosiloxanes to produce a product mixture comprising a crosslinked polysiloxane network. The invention also relates to the crosslinked polysiloxane network produced thereby. In some particular embodiments the invention further relates to a product mixture further comprising a mono-substituted silane of the structure RSiH₃, wherein R is an aliphatic, cycloaliphatic, or aromatic group. The polycondensation reaction of organofunctional silanes or siloxanes such as alkoxysilanes, acetoxysilanes, aminosilanes with silanol terminated siloxanes can be used for the formation of siloxane networks via a crosslinking process. Many of such processes require the presence of catalyst such as protic acids, Lewis acids, organic and inorganic bases, metal salts or organometallic complexes. (see, for example, (a) “The Siloxane Bond” Ed. Voronkov, M. G.; Mileshkevich, V. P.; Yuzhelevskii, Yu. A. Consultant Bureau, New York and London, 1978; and (b) Noll, W. “Chemistry and Technology of Silicones”, Academia Press, New York, 1968).

It is also well known in silicon chemistry that the organosilanol moiety will react with a hydrogen atom bonded directly to silicon (organo-hydridosilane) to produce a hydrogen molecule and the silicon-oxygen bond, (see, for example, “Silicon in Organic, Organometallic and Polymer Chemistry” Michael A. Brook, John Wiley & Sons, Inc., New York, Chichester, Weinheim, Brisbane, Singapore, Toronto, 2000). Although the uncatalyzed reaction will run at elevated temperatures, it is widely known that this reaction will run more readily in the presence of a transition metal catalyst especially noble metal catalysts such as those comprising platinum, palladium, etc., a basic catalyst such as an alkali metal hydroxide, amine, etc., or a Lewis acid catalyst such as a tin compound, etc. Recently it has been reported that organo-boron compounds are extremely efficient catalysts for the reaction between organo-hydridosilanes and organosilanols (WO 01/74938 A1) which leads to the formation of a crosslinked network. Unfortunately, the by-product of this process is dangerous, highly reactive hydrogen.

Aliphatic, cycloaliphatic, and aromatic silanes comprising Si—H functionality are typically made by the reduction of chlorosilanes. These Si—H functional silanes find use in electronic materials, semiconductors, integrated circuits, as useful intermediates for a variety of different products, and like applications. This synthesis reaction is, however, very hazardous as the reactants are very dangerous to handle. There is a continuing need to develop new reactions that will improve the versatility and safety of the processes used to make polysiloxane networks and also aliphatic, cycloaliphatic, and aromatic silanes.

### BRIEF DESCRIPTION OF THE INVENTION

In the present invention, it has been unexpectedly discovered that reacting a linear hydridosiloxane, a branched hydridosiloxane, a cyclic hydridosiloxane, or a mixture of a linear or a branched hydridosiloxane with a cyclic hydridosiloxane in the presence of an effective amount of Lewis acid catalyst yields a crosslinked polysiloxane network. It has further been discovered that the reaction can yield a silane with aliphatic, aromatic or cycloaliphatic substituents. The method described herein is a safe and convenient process to produce a crosslinked polysiloxane network and also typically silanes with aliphatic, aromatic or cycloaliphatic substituents, in contrast to the methods described in the prior art that are typically expensive and use hazardous materials.

In one embodiment, the invention relates to a method to produce a crosslinked polysiloxane network; said method comprising the step of reacting in the presence of an effective amount of a Lewis acid catalyst: either
(a) a linear or branched hydridosiloxane represented by structure (I):
   (SiHR¹O)ₐ(SiR²R³O)_{b} (I)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘a’ is an integer between 2 and 10000 and ‘b’ is an integer between 0 and 10000; or
(b) a cyclic hydridosiloxane represented by structure (II):
   (SiHR¹O)_{c}(SiR²R³O)_{d} (II)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘c’ is an integer between 2 and 10 and ‘d’ is an integer between 0 and 8, with the proviso that the sum ‘c’+‘d’ is in the range of from 3 to 10 inclusive; or
(c) a mixture of at least one linear or branched siloxane of formula (I) and at least one cyclic siloxane of formula (II).

In another embodiment, the invention relates to a method to produce (i) a crosslinked polysiloxane network and (ii) a silane of formula R¹SiH₃; said method comprising the step of reacting in the presence of an effective amount of a Lewis acid catalyst: either
(a) a linear or branched hydridosiloxane represented by structure (I):
   (SiHR¹O)ₐ(SiR²R³O)_{b} (I)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘a’ is an integer between 2 and 10000 and ‘b’ is an integer between 0 and 10000; or
(b) a cyclic hydridosiloxane represented by structure (II):
   (SiHR¹O)_{c}(SiR²R³O)_{d} (II)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R^{2;} and ‘c’ is an integer between 2 and 10 and ‘d’ is an integer between 0 and 8, with the proviso that the sum ‘c’+‘d’ is in the range of from 3 to 10 inclusive; or
(c) a mixture of at least one linear or branched siloxane of formula (I) and at least one cyclic siloxane of formula (II).

In a further embodiment, the invention relates to a crosslinked polysiloxane network comprising both residual Si—H linkages and a Lewis acid catalyst; wherein said crosslinked network is derived from
(a) a linear or branched hydridosiloxane represented by structure (I):
   (SiHR¹O)ₐ(SiR²R³O)_{b} (I)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘a’ is an integer between 2 and 10000 and ‘b’ is an integer between 0 and 10000; or
(b) a cyclic hydridosiloxane represented by structure (II):
   (SiHR¹O)_{c}(SiR²R³O)_{d} (II)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘c’ is an integer between 2 and 10 and ‘d’ is an integer between 0 and 8, with the proviso that the sum ‘c’+‘d’ is in the range of from 3 to 10 inclusive; or
(c) a mixture of at least one linear or branched siloxane of formula (I) and at least one cyclic siloxane of formula (II).

Various other features, aspects, and advantages of the present invention will become more apparent with reference to the following description and appended claims.

### DETAILED DESCRIPTION OF THE INVENTION

In the following specification and the claims which follow, reference will be made to a number of terms which shall be defined to have the following meanings. The singular forms “a”, “an” and “the” include plural referents unless the context clearly dictates otherwise.

As used herein the term “aliphatic radical” refers to an organic radical having a valence of at least one comprising a linear or branched array of atoms which is not cyclic. Aliphatic radicals are defined to comprise from one to 40 carbon atoms. The array of atoms comprising the aliphatic radical may be composed exclusively of carbon and hydrogen or may include heteroatoms such as nitrogen, sulfur, silicon, selenium and oxygen, provided that said heteroatoms do not interfere with the disproportionation reaction, for example, by partially or completely inactivating the catalyst. For convenience, the term “aliphatic radical” is defined herein to encompass, as part of the “linear or branched array of atoms which is not cyclic” a wide range of functional groups such as alkyl groups, alkenyl groups, alkynyl groups, halo alkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups and the like, provided that said functional group does not interfere with the disproportionation reaction, for example, by partially or completely inactivating the catalyst. For example, the 4-methylpent-1-yl radical is a C₆ aliphatic radical comprising a methyl group, the methyl group being a functional group which is an alkyl group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, 1,1,1-trifluoropropyl, bromodifluoromethyl, chlorodifluoromethyl, hexafluoroisopropylidene, chloromethyl; difluorovinylidene; trichloromethyl, bromodichloromethyl, bromoethyl, 2-bromotrimethylene (e.g. —CH₂CHBrCH₂—), and the like. Suitable aliphatic groups also include silyl aliphatic groups of the formula —R′—Si—(R)₃, wherein R is a monovalent C₁-C₂₀ aliphatic radical or a monovalent C₃-C₄₀ cycloaliphatic radical, and R′ is a C₂-C₁₀ aliphatic radical. By way of further example, a C₁-C₁₀ aliphatic radical contains at least one but no more than 10 carbon atoms. A methyl group (i.e. CH₃—) is an example of a C₁ aliphatic radical. A decyl group (i.e. CH₃(CH₂)₁₀—) is an example of a C₁₀ aliphatic radical.

As used herein, the term “aromatic radical” refers to an array of atoms having a valence of at least one comprising at least one aromatic group comprising from 3 to 40 carbon atoms. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals, provided that said aromatic radical does not interfere with the disproportionation reaction, for example, by partially or completely inactivating the catalyst. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like, provided that said functional group does not interfere with the disproportionation reaction, for example, by partially or completely inactivating the catalyst. For example, the 4-methylphenyl radical is a C₇ aromatic radical comprising a methyl group, the methyl group being a functional group which is an alkyl group. Aromatic radicals include halogenated aromatic radicals such as trifluoromethylphenyl, hexafluoroisopropylidenebis(4-phen-1-yloxy) (i.e. —OPhC(CF₃)₂PhO—), chloromethylphenyl; 3-trifluorovinyl-2-thienyl; 3-trichloromethylphen-1-yl (i.e. 3-CCl₃Ph-), 4-(3-bromoprop-1-yl)phen-1-yl (i.e. BrCH₂CH₂CH₂Ph-), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₈—) represents a C₇ aromatic radical.

As used herein the term “cycloaliphatic radical” refers to a radical having a valence of at least one, and comprising an array of atoms which is cyclic but which is not aromatic. The cycloaliphatic radical may comprise from 3 to 40 carbon atoms. As defined herein a “cycloaliphatic radical” does not contain an aromatic group. A “cycloaliphatic radical” may comprise one or more noncyclic components. For example, a cyclohexylmethyl group (C₆H₁₁CH₂—) is a cycloaliphatic radical which comprises a cyclohexyl ring (the array of atoms which is cyclic but which is not aromatic) and a methylene group (the noncyclic component). The cycloaliphatic radical may be composed exclusively of carbon and hydrogen or may include heteroatoms such as nitrogen, sulfur, selenium, silicon and oxygen, provided that said heteroatoms do not interfere with the disproportionation reaction, for example, by partially or completely inactivating the catalyst. For convenience, the term “cycloaliphatic radical” is defined herein to encompass a wide range of functional groups such as alkyl groups, alkenyl groups, alkynyl groups, halo alkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups and the like, provided that said functional group does not interfere with the disproportionation reaction, for example, by partially or completely inactivating the catalyst. For example, the 4-methylcyclopent-1-yl radical is a C₆ cycloaliphatic radical comprising a methyl group, the methyl group being a functional group which is an alkyl group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1 -yl, 2-chlorodifluoromethylcyclohex-1-yl, hexafluoroisopropylidene2,2-bis(cyclohex-4-yl) (i.e. —C₆H₁₀C(CF₃)₂C₆H₁₀—), 2-chloromethylcyclohex-1-yl; 3-difluoromethylenecyclohex-1-yl; 4-trichloromethylcyclohex-1-yloxy, 4-bromodichloromethylcyclohex-1-ylthio, 2-bromoethylcyclopent-1-yl, 2-bromopropylcyclohex-1-yloxy (e.g. CH₃CHBrCH₂C₆H₁₀—), and the like. Suitable cycloaliphatic groups also include silyl cycloaliphatic groups of the formula —R′—Si—(R)₃, wherein R is a monovalent C₁-C₂₀ aliphatic radical or a monovalent C₃-C₄₀ cycloaliphatic radical, and R′ is a C₂-C₁₀ cycloaliphatic radical. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

This invention relates to the unexpected discovery of a method to produce a product mixture comprising a crosslinked polysiloxane network; said method comprising the step of reacting in the presence of an effective amount of a Lewis acid catalyst: either (a) a linear or branched hydridosiloxane represented by structure (I)
(SiHR¹O)ₐ(SiR²R³O)_{b} (I)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘a’ is an integer between 2 and 10000 and ‘b’ is an integer between 0 and 10000; or (b) a cyclic hydridosiloxane represented by structure (II)
(SiHR¹O)_{c}(SiR²R³O)_{d} (II)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘c’ is an integer between 2 and 10 and ‘d’ is an integer between 0 and 8, with the proviso that the sum ‘c’+‘d’ is in the range of from 3 to 10 inclusive; or (c) a mixture of at least one linear or branched siloxane of formula (I) and at least one cyclic siloxane of formula (II). Typical R² and R³ groups include, but are not limited to, methyl, ethyl, n-propyl, isopropyl, butyl, pentyl, hexyl, decyl, dodecyl, phenyl, naphthyl, benzyl, cyclohexyl, or methylcyclohexyl. In a typical embodiment of the invention, when the siloxane reactant chosen is a linear or branched siloxane, all Si—H linkages are internal and the end groups do not contain any Si—H linkages. A typical siloxane that may be used in the invention is tetramethylcyclotetrasiloxane ((SiMe(H)O)₄; D₄^{H}; CAS # 2370-88-9). In some particular embodiments the product mixture also comprises a silane of formula R¹SiH₃. In one particular embodiment the product mixture also comprises CH₃SiH₃.

The reaction is accomplished in the presence of an appropriate catalyst. The catalyst for this reaction is preferably a Lewis acid catalyst. In some embodiments catalysts used for the reaction comprise Lewis acid catalysts of formula (III)
MR⁴ₓX_{y} (III)
wherein M is B, Al, Ga, In or Tl; each R⁴ is independently the same or different and represents a monovalent aromatic radical, such monovalent aromatic radicals preferably comprising at least one electron-withdrawing substituent; X is a halogen atom; ‘x’ is 1, 2, or 3; and ‘y’ is 0, 1 or 2; with the proviso that ‘x’+‘y’=3. In other embodiments catalysts used for the reaction comprise Lewis acid catalysts of formula (IV)
BR⁴ₓX_{y} (IV)
wherein each R⁴ is independently the same or different and represents a monovalent aromatic radical, such monovalent aromatic radicals preferably comprising at least one electron-withdrawing substituent; X is a halogen atom; ‘x’ is 1, 2, or 3; and ‘y’ is 0, 1 or 2; with the proviso that ‘x’+‘y’=3. Typical examples of such Lewis acid catalysts include, but are not limited to: 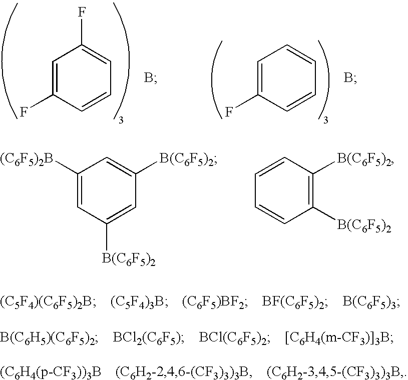
In a particular embodiment the Lewis acid catalyst is tris(pentafluorophenyl)borate (B(C₆F₅)₃; CAS # 1109-15-5).

The catalyst is typically used in an amount in a range of from about 1 ppm by weight to about 10000 ppm by weight, more preferably from about 10 ppm by weight to about 2000 ppm by weight, and most preferably from about 25 ppm by weight to about 1000 ppm by weight.

The reaction can be conducted without solvent or in the presence of one or a mixture of more than one solvent. The solvent, when present, may provide an increased ability to control viscosity, rate of the reaction and exothermicity of the process. When present, the preferred solvents comprise aliphatic hydrocarbons, aromatic hydrocarbons, halogenated hydrocarbons, as well as oligomeric cyclic diorganosiloxanes that do not comprise Si—H linkages. The reaction may be carried out at room temperature or may be carried out at higher temperatures depending upon such illustrative factors as the chemical structures of the reagents and catalysts, concentration of catalyst and the presence and type of solvent.

A typical reaction mixture is prepared by combining a reactant comprising at least one linear or branched siloxane or at least one cyclic siloxane or a mixture thereof, and a Lewis acid catalyst in the presence of an optional solvent. In one aspect of the invention, the pot life of such a formulation may optionally be extended by the addition of a stabilizing agent. Typical stabilizing agents are Lewis bases that are capable of forming complexes with a Lewis acid catalyst. Illustrative Lewis bases include, but are not limited to, ammonia, primary amines, secondary amines, tertiary amines, and organophosphines.

The reaction may be allowed to proceed until the catalyst is substantially or completely entrapped in the crosslinked polysiloxane network, becoming inaccessible to reactant, as shown by a decreasing rate of product generation. In an alternate embodiment, a quenching agent may optionally be added at any given time to stop the reaction. The quenching agents, when used, may be chosen from the group of Lewis bases that are capable of forming a strong complex with the Lewis acid catalysts. Typical quenching agents include, but are not limited to, ammonia, primary amines, secondary amines, tertiary amines, organophosphines, and basic metal oxides, illustrative examples of which comprise calcium oxide, magnesium oxide, and the like.

The products of the reaction comprise a crosslinked polysiloxane network. The crosslinked polysiloxane network typically comprises Lewis acid catalyst substantially or completely entrapped therein. The resulting product may be isolated from the reaction mixture and purified, if so desired, by typical methods known to those skilled in the art, or may be used without isolation. The crosslinked polysiloxane network finds use in many applications, including, but not limited to, siloxane elastomers, siloxane coatings, encapsulants, sealants, insulating materials and cosmetic products.

The crosslinked polysiloxane network product may still comprise significant amounts of Si—H bonds available for further reaction. It is within the scope of the invention to subject the crosslinked polysiloxane network product to further reaction with a suitable reagent, and optionally a catalyst, to convert less than 100% of the remaining residual Si—H linkages to another linkage comprising at least one of Si—OH, Si—OR, Si—R, or Si—OAr, wherein R is a monovalent C₁-C₂₀ aliphatic radical, a silyl aliphatic radical, a silyl cycloaliphatic radical, a monovalent C₃-C₄₀ aromatic radical, or a monovalent C₃-C₄₀ cycloaliphatic radical, and wherein “Ar” is a monovalent C₃-C₄₀ aromatic group.

In certain embodiments another product of the reaction is a mono-substituted silane compound represented by the formula R¹SiH₃, wherein R¹ is a monovalent aliphatic radical, a monovalent aromatic radical, or a monovalent cycloaliphatic radical. Illustrative R¹ groups on the silane include, but are not limited to, methyl, ethyl, n-propyl, isopropyl, butyl, pentyl, hexyl, decyl, dodecyl, 1,1,1-trifluoropropyl, phenyl, naphthyl, benzyl, cyclohexyl, or methylcyclohexyl group. The physical state of the silane compound depends upon such factors as the substituent on the silicon atom; and the temperature, pressure and other prevailing reaction conditions. This product may be isolated and purified, if so desired, by standard methods known to those skilled in the art. For instance, the silane product, when produced as a gas, may be condensed as such into a suitable container that may be optionally chilled to prevent evaporation or may be condensed into a solvent that may be optionally chilled to prevent evaporation. Methods to collect and store silane products are known to those skilled in the art and may be employed in the method of the present invention. The silane compounds as described herein, are useful in several applications, including, but not limited to, electronic applications in many processes such as chemical vapor deposition.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

### EXAMPLES

In the following examples tetramethylcyclotetrasiloxane [(SiMe(H)O)₄; D₄^{H}] and a linear siloxane copolymer comprising Si—H moieties were obtained from GE Silicones, Waterford, N.Y. The catalyst employed was tris(pentafluorophenyl)borate obtained from Aldrich Chemical Co., Milwaukee, Wis. Analysis of any gaseous products was performed using a gas chromatography coupled with mass spectrometer (GC/MS). Crosslinked polysiloxane networks were analyzed by solid state ²⁹Si NMR spectroscopy.

### Example 1

In a 20 milliliter (ml) glass scintillation vial equipped with a magnetic stir bar, 5 grams (g) (0.024 moles) of D₄^{H} was mixed with 0.0025 g (4.88×10⁻⁶ moles) of tris(pentafluorophenyl)borate. The vial was sealed with a plastic cap and the reaction mixture was magnetically stirred at room temperature. The reaction mixture increased in viscosity rapidly and then solidified after 5 minutes to form an elastic gel. Bubbles of gas started to form inside the gel in the next 5 minutes which led to a pressure buildup in the vial. In next few minutes the elastic gel turned into solid and brittle foam. At this point the rate of the gas formation was observed to have significantly decreased. GC/MS analysis of the released gas showed the formation of MeSiH₃ and less than 1% of Me₂SiH₂. Solid State ²⁹Si NMR analysis confirmed formation of MeSiO_{3/2} and MeSiH₂O_{1/2} groups.

### Example 2

In a 20 ml glass scintillation vial equipped with a magnetic stir bar, 5 g of a linear siloxane copolymer comprising about 50 mole % of dimethylsiloxane structural units and 50 mole % of methylhydridosiloxane structural units was mixed with 0.005 g (9.76×10⁻⁶ moles) of tris(pentafluorophenyl)borate. The vial was sealed with a plastic cap and the reaction mixture was magnetically stirred at room temperature. The reaction mixture increased in viscosity rapidly and then solidified after 5 minutes to form an elastic gel. Bubbles of gas started to form inside the gel in the next 5 minutes. In next few minutes the elastic gel turned into solid foam. At this point the rate of the gas formation was observed to have significantly decreased. GC/MS analysis of the released gas showed the formation of MeSiH₃ and less than 1% of Me₂SiH₂.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All patents and published articles cited herein are incorporated herein by reference.

1. A method to produce a crosslinked polysiloxane network; said method comprising the step of reacting in the presence of an effective amount of a Lewis acid catalyst: either
(b) a linear or branched hydridosiloxane represented by structure (I):
(SiHR¹O)ₐ(SiR²R³O)_{b} (I)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘a’ is an integer between 2 and 10000 and ‘b’ is an integer between 0 and 10000; or
(b) a cyclic hydridosiloxane represented by structure (II):
(SiHR¹O)_{c}(SiR²R³O)d (II)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘c’ is an integer between 2 and 10 and ‘d’ is an integer between 0 and 8, with the proviso that the sum ‘c’+‘d’ is in the range of from 3 to 10 inclusive; or
(c) a mixture of at least one linear or branched siloxane of formula (I) and at least one cyclic siloxane of formula (II).

2. The method of claim 1, wherein a silane of formula R¹SiH₃ is also produced, wherein R¹ is selected from the group consisting of hydrogen, a monovalent C₁-C₂₀ aliphatic radical, a monovalent C₃-C₄₀ aromatic radical, and a monovalent C₃-C₄₀ cycloaliphatic radical.

3. The method of claim 2, wherein the silane is isolated from the reaction mixture.

4. The method of claim 2, wherein the silane comprises a methyl, ethyl, n-propyl, isopropyl, butyl, pentyl, hexyl, octyl, decyl, dodecyl, 1,1,1-trifluoropropyl, phenyl, naphthyl, benzyl, cyclohexyl, or methylcyclohexyl group.

5. The method of claim 1, wherein R² and R³ are independently in each instance, methyl, ethyl, n-propyl, isopropyl, butyl, pentyl, hexyl, octyl, decyl, dodecyl, 1,1,1-trifluoropropyl, phenyl, naphthyl, benzyl, cyclohexyl, or methylcyclohexyl.

6. The method of claim 1, wherein the crosslinked polysiloxane network is isolated from the reaction mixture.

7. The method of claim 1, wherein the catalyst is used in an amount in a range of from about 1 ppm to about 10000 ppm by weight.

8. The method of claim 1, wherein the catalyst comprises boron.

9. The method of claim 8, wherein the catalyst is tris(pentafluorophenyl)borate.

10. The method of claim 1, wherein the reaction is conducted in the presence of a solvent.

11. The method of claim 1, wherein the reaction is conducted at a temperature in a range of from about 0° C. to about 150° C.

12. The method of claim 1, wherein the reaction is quenched.

13. A crosslinked polysiloxane network having residual Si—H linkages made by method of claim 1.

14. A method to produce (i) a crosslinked polysiloxane network and (ii) a silane of formula R¹SiH₃; said method comprising the step of reacting in the presence of an effective amount of a Lewis acid catalyst: either
(a) a linear or branched hydridosiloxane represented by structure (I):
(SiHR¹O)ₐ(SiR²R³O)_{b} (I)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘a’ is an integer between 2 and 10000 and ‘b’ is an integer between 0 and 10000; or
(b) a cyclic hydridosiloxane represented by structure (II):
(SiHR¹O)_{c}(SiR²R³O)_{d} (II)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘c’ is an integer between 2 and 10 and ‘d’ is an integer between 0 and 8, with the proviso that the sum ‘c’+‘d’ is in the range of from 3 to 10 inclusive; or
(c) a mixture of at least one linear or branched siloxane of formula (I) and at least one cyclic siloxane of formula (II).

15. The method of claim 14, wherein the R² and R³ are independently in each instance methyl, ethyl, n-propyl, isopropyl, butyl, pentyl, hexyl, octyl, decyl, dodecyl, 1,1,1-trifluoropropyl, phenyl, naphthyl, benzyl, cyclohexyl, or methylcyclohexyl.

16. The method of claim 14, wherein the crosslinked polysiloxane network is isolated from the reaction mixture.

17. The method of claim 14, wherein the silane is isolated from the reaction mixture.

18. The method of claim 14, wherein the Lewis acid catalyst comprising boron is tris(pentafluorophenyl)borate.

19. The method of claim 14, wherein the reaction is conducted at a temperature in a range of from about 0° C. to about 150° C.

20. The method of claim 14, wherein the reaction is conducted in the presence of a solvent.

21. A method to produce (i) a crosslinked polysiloxane network and (ii) a silane of formula R¹SiH₃; said method comprising the step of reacting, at room temperature, in the presence of about 100 ppm by weight of tris(pentafluorophenyl)borate catalyst, and optionally in the presence of a solvent: either
(a) a linear or branched hydridosiloxane represented by structure (I):
(SiHR¹O)ₐ(SiR²R³O)_{b} (I)
wherein R² and R³ are independently in each instance methyl, ethyl, n-propyl, isopropyl, butyl, pentyl, hexyl, octyl, decyl, dodecyl, phenyl, naphthyl, benzyl, cyclohexyl, or methylcyclohexyl; R¹ is hydrogen or the same as R²; and ‘a’ is an integer between 2 and 10000 and ‘b’ is an integer between 0 and 10000; or
(b) a cyclic hydridosiloxane represented by structure (II):
(SiHR¹O)_{c}(SiR²R³O)_{d} (II)
wherein R² and R³ are independently in each instance methyl, ethyl, n-propyl, isopropyl, butyl, pentyl, hexyl, octyl, decyl, dodecyl, phenyl, naphthyl, benzyl, cyclohexyl, or methylcyclohexyl; R¹ is hydrogen or the same as R²; and ‘c’ is an integer between 2 and 10 and ‘d’ is an integer between 0 and 8, with the proviso that the sum ‘c’+‘d’ is in the range 3 to 10 inclusive; or
(c) a mixture of at least one linear or branched siloxane of formula (I) and at least one cyclic siloxane of formula (II).

22. A crosslinked polysiloxane network comprising both residual Si—H linkages and a Lewis acid catalyst.

23. The crosslinked polysiloxane network of claim 22, wherein said crosslinked network is derived from
(a) a linear or branched hydridosiloxane represented by structure (I):
(SiHR¹O)ₐ(SiR²R³O)_{b} (I)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘a’ is an integer between 2 and 10000 and ‘b’ is an integer between 0 and 10000; or
(b) a cyclic hydridosiloxane represented by structure (II):
(SiHR¹O)_{c}(SiR²R³O)_{d} (II)
wherein R² and R³ are independently in each instance a monovalent C₁-C₂₀ aliphatic radical, a monovalent C₃-C₄₀ aromatic radical, or a monovalent C₃-C₄₀ cycloaliphatic radical; R¹ is hydrogen or the same as R²; and ‘c’ is an integer between 2 and 10 and ‘d’ is an integer between 0 and 8, with the proviso that the sum ‘c’+‘d’ is in the range of from 3 to 10 inclusive; or
(c) a mixture of at least one linear or branched siloxane of formula (I) and at least one cyclic siloxane of formula (II).

24. The crosslinked polysiloxane network of claim 22, wherein the Lewis acid catalyst is tris(pentafluorophenyl)borate.

25. The crosslinked polysiloxane network of claim 22, wherein less than 100% of the remaining residual Si—H linkages are subsequently converted to another linkage comprising at least one of Si—OH, Si—OR, Si—R, or Si—OAr, wherein R is a monovalent C₁-C₂₀ aliphatic radical, a silyl aliphatic radical, a silyl cycloaliphatic radical, a monovalent C₃-C₄₀ a monovalent C₃-C₄₀ aromatic radical, or a monovalent C₃-C₄₀ cycloaliphatic radical; and wherein Ar is a monovalent C₃-C₄₀ aromatic group.
